(19) United States
(12) Patent Application Publication
(10) Pub. No.: US 2011/0153370 A1
(43) Pub. Date: Jun. 23, 2011

(54) SYSTEM, METHOD AND PRODUCT FOR INTELLECTUAL PROPERTY TITLE PROTECTION

(76) Inventor: Thomas F. Gillespie, III, Towson, MD (US)

(21) Appl. No.: 12/737,886

(22) PCT Filed: Sep. 2, 2009
(86) PCT No.: PCT/US2009/055740

§ 371 Date: Feb. 25, 2011

Related U.S. Application Data
(60) Provisional application No. 61/136,384, filed on Sep. 2, 2008.

(51) Int. Cl. G06Q 40/00; G06Q 50/00

(52) U.S. Cl. 705/4; 705/310

(57) ABSTRACT

The system, method and product of the present invention provides protection against an unknown defect in the title of an intellectual property asset (IPA) having various intellectual property rights (IPRs) associated therewith. Through due diligence, a variety of defects or title encumbrances are identified and investigated, and, if possible, cured.

### CROSS-REFERENCE TO RELATED APPLICATIONS

This application claims priority to international patent application PCT/US2009/055740, filed Sep. 9, 2009, entitled “SYSTEM, METHOD AND PRODUCT FOR INTELLECTUAL PROPERTY TITLE PROTECTION,” and U.S. Provisional Application Ser. No. 61/136,384, filed Sep. 2, 2008, entitled “SYSTEM, METHOD AND PRODUCT FOR THE PROTECTION AGAINST A DEFECT IN TITLE OF AN INTELLECTUAL PROPERTY ASSET,” the disclosures of which are incorporated herein by reference.

### FIELD OF THE INVENTION

The present invention relates to techniques to improve the protection of intellectual property assets and clarifying the rights thereto, and more particularly relates to protection against adverse consequences of a defect in the title to an intellectual property asset.

### BACKGROUND OF THE INVENTION

Patents, trademarks, service marks, trade secrets, mask works, trade dress rights and copyrights, referred to collectively herein as “intellectual property assets” (IPAs), provide an owner with the right to exclude others from making, using, selling, offering for sale, or importing a particular product or service. Such intellectual property rights (IPR) have become quite valuable articles of commerce as society continues to shift toward knowledge-based technologies, with IPR often forming the bulk of corporate valuation. As with land and various objects, ascertaining title and ownership of IPR assets is critical in transfers, licensing and other interactions between buyers and sellers.

Ascertaining ownership and title for intangible assets, however, is quite complicated since intangible assets like IPR are quite unlike physical objects or land, where the res or thing speaks for itself. Intellectual property rights can, for example, be created by several different parties collaborating together in different places at the same time, can be implied within a work such as a patent and otherwise be less obvious than corresponding rights associated with physical things. For example, unlike a physical asset or a real property asset, an IPR could vest in multiple parties simultaneously who are each in a different location and thus governed by a different local inventorship/IPR ownership law. What is more, in some cases, a party could be entitled to inventorship rights, and not immediately be aware of it, thereby creating a potential or actual interest dependent on future events, e.g., issuance of a patent. Akin to springing executory interests in property law, IP rights may suddenly appear, although in actuality their potential was present at all times.

When a business or portion of a business is sold or an intellectual property asset licensed, the purchaser and/or the licensee usually conducts a limited “due diligence” analysis to determine whether the person purporting to provide them with clear title to the intellectual property asset(s) to be purchased or licensed can legally do so. Because an extensive analysis of the intellectual property asset(s) involves both legal and business value analysis and contains some unknown and even some unknowable elements, the purchaser of a business or business unit and/or the licensee of an intellectual property asset necessarily must assume some degree of risk related to the clarity of their claim to title to the intellectual property assets being purchased and/or licensed.

As with other types of assets bearing risks, it would therefore be useful to provide a system, method and product for spreading the risk associated with a purchase or licensing of intellectual property assets among one or more parties, some of whom are neither purchasers nor sellers of the assets.

In view of the aforementioned subtleties of IPR title determinations, there is, therefore, a present need for techniques to minimize the inherent risk involved in transactions involving IPRs, which increasingly are almost all business transactions.

An object of the present invention is to provide a method for spreading the financial risks associated with the purchase, ownership, practice and use of intellectual property assets.

Another object of the present invention is to provide an insurance product which protects purchasers (interested parties) against defects in the title of intellectual property assets that they buy or license.

A further object of the present invention is to provide a method of insuring that the seller or licensor of patents, trademarks, copyrights and/or other intellectual property assets possesses such title when he or she attempts to sell or license the intellectual property asset in question to the buyer/licensee, such that he or she, as the seller/licensor, can pass marketable title to the buyer/licensor at the time of the transaction.

Another object of the present invention is to provide insurance for patents and other intellectual property assets in the context of acquisitions and mergers.

Yet another object of the present invention is to provide insurance for patents and other intellectual property assets in the context of public market sales of multiple licenses for intellectual property assets.

A further object of the present invention is to provide insurance for patents and other intellectual property assets in the context of private market sales of one or many licenses for intellectual property assets.

Another object of the present invention is to provide insurance for patents and other intellectual property in the context of exclusive licensing transactions.

A further object of the present invention is to provide insurance for patents and other intellectual property in the context of non-exclusive licensing transactions.

Yet another object of the present invention is an insurance product that provides insurance to interested parties for their intellectual property assets covered under the product against claims to the financial enjoyment, possession, use, or control of the intellectual property asset under review, or any derivative works if any, brought by a third-party who is not the interested party(s).

Other objects of the present invention will become apparent from the remainder of the specification and the claims.

### SUMMARY OF THE INVENTION

The present invention is directed to various methods, systems and products that identify and minimize the risk inherent in transactions involving intellectual property assets (IPA), the titles for which may be encumbered in subtle ways.

The system, method and product of the present invention provides protection against an unknown defect in the title of an intellectual property asset (IPA) having various intellectual property rights (IPRs) associated therewith. Through due diligence, a variety of defects or title encumbrances are identified and investigated, and, if possible, cured.

A corresponding data processing system, insurance proposal form and computer-generated insurance policy form also are described herein. The method, system and products/forms of the invention can be used, for example, as part of a “due diligence” analysis in the context of the purchase and/or sale and assignment of IPAs, for the licensing of those assets, the public auction of the assets, the public sale of shares of the asset, and other uses, dispositions or transfers.

### BRIEF DESCRIPTION OF THE DRAWINGS

The features, aspects, and advantages of the present invention will become better understood with regard to the following Detailed Description, appended claims, and accompanying drawings, where:

FIG. 1 is an operational flowchart of various aspects of the present invention; and

FIG. 2 illustrates a transaction involving the intellectual property asset pursuant to the teachings of the present invention.

### DETAILED DESCRIPTION OF THE PREFERRED EMBODIMENTS

The following detailed description is presented to enable any person skilled in the art to make and use the invention. For purposes of explanation, specific nomenclature is set forth to provide a thorough understanding of the present invention. However, it will be apparent to one skilled in the art that these specific details are not required to practice the invention. Descriptions of specific applications are provided only as representative examples. Various modifications to the preferred embodiments will be readily apparent to one skilled in the art, and the general principles defined herein may be applied to other embodiments and applications without departing from the scope of the invention. The present invention is not intended to be limited to the embodiments shown, but is to be accorded the widest possible scope consistent with the principles and features disclosed herein.

As discussed, the value of intellectual property assets (IPAs) and intellectual property rights (IPRs) attendant thereto have increased dramatically over the past few decades to in many cases dominant corporate holdings. Ascertaining ownership interests, e.g., title, is somewhat more difficult for these assets in view of some complexities in the creation, maintenance and transference of these IPAs. The present invention is directed to techniques, systems, methods and products that attempt to manage risk associated with IPA instruments embued with IPR, and determine any “title” defects associated therewith, thereby providing a valuable mechanism to protect the interests of owners and purchasers of IPA instruments, the currency of today's economy.

One problem encountered when dealing with IPA instruments is the inadequacy and vagueness of many existing insurance products relating to IPR. With the complexities and subtleties of IPR it is not surprising that quantifying the risks associated with an IPA is quite difficult, leading many policies with limitations on the degree of risk involved.

The present invention is directed to a variety of techniques for protecting against IPR defects, some of which are set forth below. For example, a preferred embodiment of the present invention is a system, method and product for providing protection against a defect in title of an IPA, comprising:
(i) entering into business negotiations with an interested party in order to sell them an insurance product that provides them with the protections against the occurrence of the risk events described in the relevant IPA title protection policy;
(ii) performing steps (a) through (r), as described hereinbelow, to insure that the risks associated with the extension of such coverage are appropriate,
(iii) obtaining payment for the insurance product from the interested party, and
(iv) paying any and all claims made by the interested party, if and when a third-party rightfully and correctly asserts that they have a right to the financial enjoyment, possession, use, or control of the IPA under review, or any derivative works if any, which was unknown to the interested party and the insuring party at the time the insurance product was purchased.

In view of the complexity in the determination of intellectual property rights within IPAs, Applicant has formulated a technique for analyzing these assets for trouble spots, identifying the problems areas, and providing potential cures to remedy deficiencies. A preferred form of the present invention is a method of providing protection against a defect in title of an IPA, comprising a variety of potential actions performed in the identification and investigation of the actual or potential defects, including:

(a) obtaining a description of at least one IPA from an inquiring party,

(b) determining what legal regime provides protection for the IPA,

(c) performing a search within the relevant government records depository to determine the official chain of custody of the IPA,

(d) performing a search within the relevant government records depository (e.g.—a U.S. Article 9 State filing office) to determine whether there are any liens, judgments, or other encumbrances that have ever or are currently encumbering the IPA,

(e) examining each party within the publicly-discoverable chain of custody of the IPA from the creator and/or originator to the inquiring party to determine whether each party paid any and all relevant state, local and federal taxes while they were the legal title holder of the IPA in question,

(f) performing a search within the relevant government records depository to determine whether assignments were properly recorded as the IPA under review passed from one party to another,

(g) interviewing the original inventor or creator, if possible, to obtain an understanding of how and when the invention embodied within the IPA under review was created,

(h) interviewing all parties even tangentially involved in the creation and/or origination of the IPA under review to determine whether the proper parties were listed as inventors and/or authors of the IPA under review according to the local inventorship/IP ownership law applicable to each purported inventor or author at the time their inventive contribution was made,

(i) interviewing all parties involved in the creation and/or origination of the IPA under review to determine whether any parties involved with the creation or origination of the IPA under review engaged in any conduct that could or might be considered inequitable conduct under US federal or state law, or under the law of any relevant foreign country,

(j) performing a search within the relevant government records depository to determine whether any applicable maintenance fees were paid promptly and in full within the allotted time under applicable law,

(k) performing a search within the relevant government records depository to determine whether any parties within the chain of custody or who were in any way involved in the creation or origination of the IPA under review attempted to or did bequeath or in any other way transfer whatever rights they might have had, or that they might have thought they had, in the IPA to some third-party,

(l) examining any available “as filed” putative assignment documents to determine whether they were properly signed, and to ensure that the assignor in each case did not hold back any reversionary interest,

(m) examining each inventor or interest holder in the chain of custody of the IPA to determine whether any such person is now, or was ever a citizen of or located within a country or jurisdiction that provides special rights to inventors, e.g.—Germany, Austria, etc., during any activities related to their ownership or inventorship of the IPA,

(n) examining the public records of any corporate entity that ever had an interest in the IPA to determine if there are any publicly-discoverable transfers that were not recorded, for whatever reason, at the official government records depository that nevertheless might constitute legally valid transfers of an interest in such IPA to a third party,

(o) examining the file history of the IPA, if any, to determine whether the assignee or owner of the IPA, or their agents or designees engaged in any conduct that could be construed as inequitable conduct in the US or in any foreign country at the time of the IPA's prosecution/examination,

(p) examining the employment agreements of any employees even tangentially involved in the creation and/or origination of the invention embodied within the IPA under review to determine whether they had a legally binding obligation under the applicable local law to assign their rights in any inventions they might make to their employer, or whether, in the alternative that such a transfer might be lacking consideration or otherwise defective,

(q) obtaining any private transfer documents that are not available via the public records that relate to the IPA to determine if any unknown third-parties have rights in the IPA,

(r) examining any publicly-available financial statements and records for all parties within the chain of title between the originators and/or inventors of the IPA and the interested party to determine whether they had, at the time they possessed or thought they possessed an interest in the IPA, a financial motivation or need to engage in conduct that potentially could be seen as inequitable conduct in the US or in any relevant foreign jurisdiction or to instruct their agents to engage in such conduct.

In a preferred form of the present invention, the system, method and product are executed through a computer program.

In another preferred form of the present invention, the method comprises a data processing system, either executed by a computer, processor or other physical operational component.

In another preferred form of the present invention, the interested party contracts with the insuring party, who agrees to indemnify the interested party if and when some third-party asserts that they have a superior claim to the IPA under review in a judicial proceeding, provided that certain pre-conditions are met. Those preconditions being one or more of the steps outlined and described hereinabove as steps (a) through (r).

In another preferred embodiment of the present invention, the interested party contracts with the insuring party, who agrees to indemnify the interested party up to a certain amount stated in the insurance contract (policy limit), in the event that some third-party asserts that they have some claim to the IPA under review, provided that certain pre-conditions are met. Those preconditions being one or more of the steps outlined and described hereinabove as steps (a) through (r).

In another preferred form of the invention the interested party contracts with the insuring party, who agrees to indemnify the interested party to a certain sum certain stated in the insurance product (policy limit), in the event that some third-party asserts that they have a superior claim to a right or rights associated with the IPA under review, provided that certain pre-conditions are met. Those preconditions being one or more of the steps outlined and described hereinabove as steps (a) through (r). In this form of the invention the overall risk that is transferred from the interested party to the insuring party or parties can and often is shared according to a staggered schedule of policy limits, e.g., the first insuring party agrees to indemnify the interested party in the event that certain events happen up to a sum certain (e.g., $10M), with a second insuring party agreeing do the same for amounts claimed by the interested party that are greater than $10M but less than $50M, etc.

The “IPA” preferably includes at least one member selected from the group consisting of authorship rights, patent rights, patent application rights, trademark rights, service mark rights, copyright rights, mask works, trade secret rights and trade dress rights.

The “inquiring party” preferably is a client, an officer of a client, a director of a client, a prospective purchaser or licensee of the IPA or assets under review, or a director or officer of the prospective purchaser or licensee.

The “legal regime” in step (b) preferably is either the trade secret law of the jurisdiction where the trade secrete was housed and/or created, patent law, copyright law, trademark and trade dress law, mask work law, copyright law, or some other law designed to provide rights and protections to applicable IPAs anywhere in the world.

The “relevant government records depository” referenced in the aforementioned steps comprises the federal USPTO records for United States patents, trademarks and trade dress, the federal repository for copyrights, and state law personal property archives if and to the extent that they exist, and other similarly situated government, quasi-government and other organizations around the world that perform the same or similar tasks relating to IPRs and general intangible assets created or owned within their jurisdiction.

The “chain of custody” in the aforementioned steps comprises the list of legal persons who have ever had any legal right to the IPA under review according to the office where such records are kept and/or where perfected interests in such property can be obtained.

The “official chain of custody” described in step (c) means the publicly-available list of assignments or title transfers housed or made available by organizations like the USPTO, WIPO, and other similarly situated organizations that maintain archives of assignments for intangible assets, particularly those that maintain such records for IPAs.

Applicant respectfully submits that one person skilled in the art will understand what is meant by an “as filed” putative assignment document in step (l).

Applicant respectfully submits that one person skilled in the art will understand what is meant by the term “special rights” to inventors.

The “official government records depository” referenced in step (n) comprises offices like the USPTO in the United States, and other similarly-situated organizations around the world that examine patent applications and issue patent grants after the culmination of those examinations on claims that have been deemed allowed. In a particularly preferred embodiment of the present invention, the IPA or assets include at least one patent right. The IPAs covered by the method of the invention also can include pending patent applications, e.g., provisional, utility, design, plant, domestic and foreign.

The method of the invention most is preferably directed to a situation in which compensation is offered to the insuring party in connection with (e.g., upon, after or subject to) transfer of ownership of the IPA or assets to a buyer, or licensing of the assets, either exclusive or non-exclusive, from a seller and/or licensor.

Another preferred embodiment of the present invention is a method of insuring against a risk of a defect in the title of a patent right, comprising:

performing steps (a) through (r) on behalf of a buyer and/or licensee and in so doing,

determining that there are no liens, mortgages or other encumbrances on the patent(s) under evaluation,

determining that the proper persons were listed as inventors and that there was no inequitable conduct on the part of anyone who possessed rights in the patent(s) under evaluation during the time that said persons possessed such rights or any time reasonable therebefore or thereafter, and

agreeing to provide compensation to a person with an interest in the inquiring party to pay for a portion of any loss experienced by the inquiring person as a result of their purchase of the patent or of their payment for a license to the patent under review during a particular period of time after receipt of an insurance premium, the insurance premium being paid in connection with a transfer of ownership or licensing, either exclusive or nonexclusive, of the patent right.

A further preferred embodiment of the present invention is a method of insuring against a risk of a defect in the title of an intellectual property right, comprising:

performing steps (a) through (r) on behalf of a buyer and/or licensee and in so doing,

determining that there are no liens, mortgages or other encumbrances on the IPA under evaluation,

determining that the proper persons were listed as inventors and/or originators for the intellectual asset under review and assuring that that there was no inequitable conduct on the part of anyone who possessed rights in the intellectual asset under review during the time that said persons possessed such rights or any time reasonable therebefore or thereafter, and

agreeing to provide compensation to a person with an interest in the inquiring party to pay for a portion of any loss experienced by the inquiring person as a result of their purchase of the intellectual asset under review or of their payment for a license to the intellectual asset under review during a particular period of time after receipt of an insurance premium, the insurance premium being paid in connection with a transfer of ownership or licensing, either exclusive or nonexclusive, of the intellectual asset under review.

In another preferred embodiment of the present invention, there is a data processing system and/or computer program for use in administering an insurance program to insure against the occurrence of an event that clouded or impaired the title to an IPA, comprising:

(a) performing the aforementioned steps (a) through (r) for a given IPA, and

(b) means for calculating a proposed insurance premium based upon a percentage of the overall deal value being insured.

A further preferred embodiment of the present invention is an insurance proposal form, comprising:

a plurality of first pattern areas including alphanumeric characters representing a set of insurable IPAs owned by a seller/licensor,

a plurality of second pattern areas including alphanumeric characters representing a likelihood that one or more particular IPAs in the set would be found to have defects in their title, and

a plurality of third pattern areas including alphanumeric characters representing a proposed premium for insuring against an unexpected event that caused the title to the insured IPAs to become clouded or unmarketable.

The insurance proposal form preferably further comprises a plurality of fourth pattern areas including alphanumeric characters representing a person designated to receive the insurance proposal form, said person being a party with an interest in the inquiring party.

Yet another preferred embodiment of the present invention is an insurance proposal form or product, comprising:

a plurality of first pattern areas including alphanumeric characters representing a set of insurable IPAs owned by a seller/licensor,

a plurality of second pattern areas including alphanumeric characters representing a likelihood that one or more particular IPAs in the set would be found to have defects in their title, and

a plurality of third pattern areas including alphanumeric characters representing a second party designated to receive the insurance proposal form, the second party being a proposed purchaser or licensee of the insurable IPA(s).

In yet another preferred embodiment, the present invention is a computer-generated insurance policy form offering to insure at least a portion of the value of at least one IPA exclusive of legal fees, the insurance policy form being generated in connection with a proposed transfer of ownership or a licensing transaction of said at least one IPA. The policy form preferably is directed to patent or copyright rights.

Yet another preferred embodiment of the present invention is a computer-generated insurance form for protecting a right to practice technology which is described in an agreement to transfer IPAs of a company, the computer-generated insurance form being generated in connection with a proposal to transfer ownership of the IPAs from a first party to a second party.

A further embodiment of the present invention is an insurance policy for insuring at least a portion of the value of an IPA, the insurance policy becoming effective at a time of transfer of ownership or at the moment the license to the IPA becomes effective.

Another embodiment of the present invention is a method of insuring intellectual property which includes the above-described method of providing protection against the occurrence of an event which clouded the title to IPA such that it became less than marketable, and also includes other types of insurance protection for the intellectual property, such as, for example, payment of legal fees and other expenses associated with the enforcement of intellectual property rights.

Further embodiments of the present invention are a method and an insurance product for protecting a right to practice technology which is described in an agreement to transfer IPAs of a company, the term of the insurance commencing at the time of transfer of the assets from a first party to a second party.

The present invention, accordingly, comprises the several steps and the relation of one or more of such steps with respect to each of the others and the article possessing the features, properties, and the relation of elements exemplified in the following examples.

### PROPHETIC EXAMPLES

### Example 1

The method is practiced in the context of a license agreement between two parties, where the buyer/licensee is the “interested party”.

### Example 2

The method is practiced in the context of a sale of multiple non-exclusive licenses to the IPA under review where the interested party is the clearing house or investment bank or bank engaged in underwriting the sale of the IPA under review.

### Example 3

The method is practiced in the context of a sale of multiple non-exclusive licenses to the IPA under review where the interested party is the seller/licensee who has engaged an investment banc or bank or clearing house to underwrite the sale or licensing of the IPA under review.

### Example 4

The method is practiced in the context of a sale of multiple non-exclusive licenses to the IPA under review where the interested party is the buyer who has purchased a license or right to an absolute assignment of rights from an investment banc or bank or clearing house who were underwriting the sale or licensing of the IPA under review.

### Example 5

The method is practiced in the context of a sale of licenses to the IPA under review where the interested party is the buyer who has purchased a license or right to an absolute assignment of rights from an from a third party in a private non-public market transaction.

### Example 6

The method is practiced in the context of a sale of licenses to the IPA under review where the interested party is the seller who is selling a right to license or a right to an absolute assignment of the rights in an IPA under review to a third party in a private non-public market transaction.

### Example 7

The method is practiced in the context of a sale of assets or merger of a two corporations where the intellectual property under review is an asset owned by the party being sold or participating in the merger and the interested party is the buyer, seller, buyer's agent, seller's agent or some other party with an interest in the transaction.

With the aforementioned embodiments of the present invention and prophetic examples thereof described, the following illustrations further elaborate upon the various manifestations of the principles set forth herein and claimed.

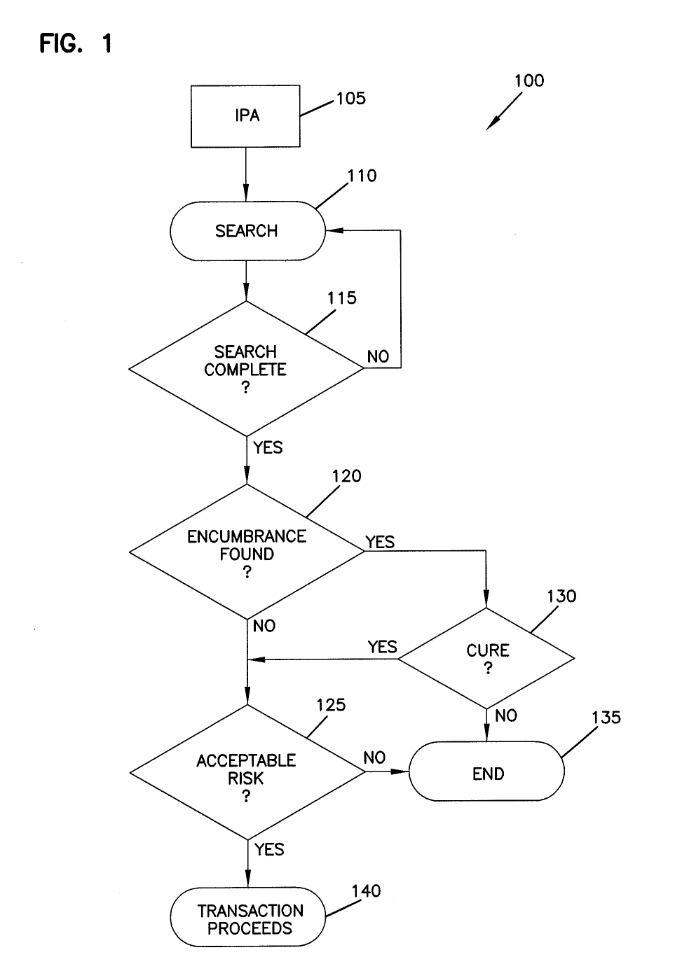

With reference now to FIG. 1 of the Drawings, there is illustrated therein an operations flowchart, generally designated by the reference numeral 100, of aspects of the present invention. An IPA 105 under consideration is identified and a search, generally designated by the reference numeral 110, is performed of various records, as described hereinabove, for potential encumbrances to the ownership, use or transference thereof. While the search 110 is progressing, a check is made periodically on the status of the search, a conditional generally designated in FIG. 1 by the reference numeral 115, to ascertain if the search 110 is complete. If so, control passes to an encumbrances conditional, designated by the reference numeral 120. If the search is not complete at status check 115, further searching 110 is performed.

After perusal of the various records and checks regarding the bona fides of the IPA 105, if no encumbrances are found, control passes to a check on whether the IPA presents an acceptable risk, designated by the reference numeral 125. However, if an encumbrance is found, control passes to a check on whether or not that encumbrance or defect in the IPA 105 can be cured, designated by reference numeral 130. If curable, control passes to the aforementioned acceptable risk check 125. If not curable, however, then consideration of the IPA 105 is likely at an end, designated by the reference numeral 135. Nonetheless, even if the IPA 105 bears a problematic risk, then the transaction could still proceed, perhaps with a lower price or fewer obligations involved, the risk then being deemed acceptable, where the control would then pass to the acceptable risk check 225, as discussed.

In any event, with the encumbrances enumerated and investigated, cures attempted or accomplished, risks assessed and accepted, control then passes to proceed with the transaction, i.e., the license, sale, indemnification, etc. of the IPA 105, generally designated by the reference numeral 140.

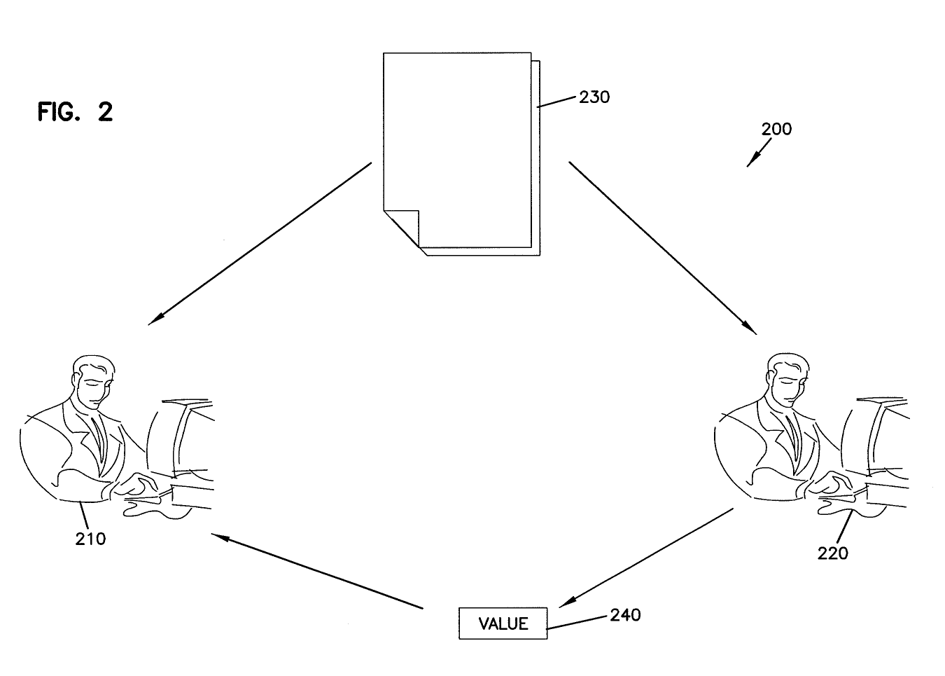

With reference now to FIG. 2 of the Drawings, there is illustrated therein a representation of various ways the principles of the present invention may be employed, generally designated by the reference numeral 200. As shown, two parties, generally designated by the reference numerals 210 and 220, respectively, are negotiating a transaction involving an IPA 230 in exchange for some value, generally designated by the reference numeral 240.

As described hereinabove, parties 210 and 220 may be negotiating an ownership transference of IPA 230 in exchange for money or other value 240. Parties 210 and 220 may alternatively represent a licensor and licensee, negotiating a license or use of the IPA 230 in exchange for money, a cross license with other IPAs or other value 240.

Alternatively, the parties, particularly party 220, may require insurance that the IPA 230 has adequate title for the transaction, i.e., not subject to attack from third parties, and if so attacked, the risk of survival is good.

It should, of course, be understood that party 220, in investigating the worth of the offered IPA 230, e.g., in connection with a transference, would perform a due diligence on the IPA 230, such as illustrated in FIG. 1 and described in detail hereinabove. A third party may also be involved to facilitate the arrangement or perform the requisite background checks on the IPA 230, e.g., a due diligence searcher of the various official and unofficial records involving the IPA 230, as well as interviews and meetings with inventors and other parties of interest, as described in more detail hereinabove. Additionally, as discussed, a third party, such as an indemnifier or other third party of interest to the transaction, may be involved to facilitate or seal the deal, pursuant to the results of the comprehensive identification and due diligence analysis performed on the IPA 230, such as shown in FIG. 1 and described in detail herein.

Various other scenarios with the parties 210 and 220 involving insurance and indemnification are discussed hereinabove, and equally applicable to the arrangement illustrated in FIG. 2.

The previous description is of preferred embodiments for implementing the invention and should not necessarily be limited by the description. The scope of the invention is instead described by the following claims:

1. A method for protecting against defects in the title of an intellectual property asset, comprising:
identifying at least one electronic database containing records therein pertaining to title in an intellectual property asset;
retrieving at least one electronic database record on said intellectual property asset from said at least one electronic database;
analyzing said at least one electronic database record for data on title and other defects of said intellectual property asset; and
assessing risk associated with said title and other defects of said intellectual property asset,
whereby said risk in the title and other defects for said intellectual property asset is minimized, reduced or spread.

2. The method according to claim 1, wherein said step of analyzing comprises a check step,
said check step being selected from the group consisting of: (a) obtaining a description of at least one IPA from an inquiring party, (b) determining what legal regime provides protection for the IPA, (c) performing a search within the relevant government records depository to determine the official chain of custody of the IPA, (d) performing a search within the relevant government records depository (e.g.—a U.S. Article 9 State filing office) to determine whether there are any liens, judgments, or other encumbrances that have ever or are currently encumbering the IPA, (e) examining each party within the publicly-discoverable chain of custody of the IPA from the creator and/or originator to the inquiring party to determine whether each party paid any and all relevant state, local and federal taxes while they were the legal title holder of the IPA in question, (f) performing a search within the relevant government records depository to determine whether assignments were properly recorded as the IPA under review passed from one party to another, (g) interviewing the original inventor or creator, if possible, to obtain an understanding of how and when the invention embodied within the IPA under review was created, (h) interviewing all parties even tangentially involved in the creation and/or origination of the IPA under review to determine whether the proper parties were listed as inventors and/or authors of the IPA under review according to the local inventorship/IP ownership law applicable to each purported inventor or author at the time their inventive contribution was made, (i) interviewing all parties involved in the creation and/or origination of the IPA under review to determine whether any parties involved with the creation or origination of the IPA under review engaged in any conduct that could or might be considered inequitable conduct under US federal or state law, or under the law of any relevant foreign country, (j) performing a search within the relevant government records depository to determine whether any applicable maintenance fees were paid promptly and in full within the allotted time under applicable law, (k) performing a search within the relevant government records depository to determine whether any parties within the chain of custody or who were in any way involved in the creation or origination of the IPA under review attempted to or did bequeath or in any other way transfer whatever rights they might have had, or that they might have thought they had, in the IPA to some third-party, (l) examining any available “as filed” putative assignment documents to determine whether they were properly signed, and to ensure that the assignor in each case did not hold back any reversionary interest, (m) examining each inventor or interest holder in the chain of custody of the IPA to determine whether any such person is now, or was ever a citizen of or located within a country or jurisdiction that provides special rights to inventors, e.g.—Germany, Austria, etc., during any activities related to their ownership or inventorship of the IPA, (n) examining the public records of any corporate entity that ever had an interest in the IPA to determine if there are any publicly discoverable transfers that were not recorded, for whatever reason, at the official government records depository that nevertheless might constitute legally valid transfers of an interest in such IPA to a third-party, (o) examining the file history of the IPA, if any, to determine whether the assignee or owner of the IPA, or their agents or designees engaged in any conduct that could be construed as inequitable conduct in the US or in any foreign country at the time of the IPA's prosecution/examination, (p) examining the employment agreements of any employees even tangentially involved in the creation and/or origination of the invention embodied within the IPA under review to determine whether they had a legally binding obligation under the applicable local law to assign their rights in any inventions they might make to their employer, or whether, in the alternative that such a transfer might be lacking consideration or otherwise defective, (q) obtaining any private transfer documents that are not available via the public records that relate to the IPA to determine if any unknown third-parties have rights in the IPA, (r) examining any publicly-available financial statements and records for all parties within the chain of title between the originators and/or inventors of the IPA and the interested party to determine whether they had, at the time they possessed or thought they possessed an interest in the IPA, a financial motivation or need to engage in conduct that potentially could be seen as inequitable conduct in the US or in any relevant foreign jurisdiction or to instruct their agents to engage in such conduct.

3. A system for protecting against defects in the title of an intellectual property asset, comprising:
identification means for identifying at least one electronic database containing therein records pertaining to title in an intellectual property asset;
retrieving means for retrieving at least one electronic database record on said intellectual property asset from said at least one electronic database;
analyzing means for analyzing said at least one electronic database record for data on title and other defects of said intellectual property asset; and
assessing means for assessing risk associated with said title and other defects of said intellectual property asset,
whereby said risk in the title and other defects for said intellectual property asset is minimized, reduced or spread.

4. A product for protecting against defects in the title of an intellectual property asset, comprising:
a recitation of records identified pertaining to an intellectual property asset, said records from at least one electronic database;
a recitation of title and other defects identified pertaining to said intellectual property asset;
a recitation of risks associated with said title and other defects in said intellectual property asset,
whereby said risks in the title and other defects for said intellectual property asset are minimized, reduced or spread.

5. The method according to claim 1, wherein the time from initiation of the process to the end can be completed in less than 1 week.

6. The method according to claim 1, wherein the initiation of the process is preceded by the provision of a series of inputs about the intellectual property asset by a user.

7. The method according to claim 6, wherein the process can be completed in less than 1 week.

8. The method according to claim 6, wherein the input that precedes the initiation of the process is communicated via a point and click computer-user interface presented to the user via the internet.

9. The method according to claim 8, wherein the process can be completed in less than 1 week.

10. The method according to claim 6, wherein the input that precedes the initiation of the process is communicated via a point and click computer-user interface presented to the user via a mobile phone app.

11. The method according to claim 10, wherein the process can be completed in less than 1 week

12. The method according to claim 6, wherein the input that precedes the initiation of the process is communicated via a point and click computer-user interface presented to the user via a tablet computer device.

13. The method according to claim 12, wherein the process can be completed in less than 1 week.

14. The method according to claim 2, wherein one or more check steps can be completed in less than 1 week.

15. The method according to claim 2, wherein one or more check-steps are preceded by the communication of a series of inputs about the intellectual property asset by a user.

16. The method according to claim 15, wherein the input that precedes the initiation of one or more check-steps is communicated via a point and click computer-user interface presented to the user via a mobile phone app.

17. The method according to claim 16, wherein one or more checks steps can be completed in less than 1 week

18. The method according to claim 15, wherein the input that precedes the initiation of one or more check-steps is communicated via a point and click computer-user interface presented to the user via the internet.

19. The method according to claim 18, wherein one or more checks steps can be completed in less than 1 week

20. The method according to claim 15, wherein the input that precedes the initiation of one or more check-steps is communicated via a point and click computer-user interface presented to the user via a tablet computer device.

21. The method according to claim 20, wherein one or more checks steps can be completed in less than 1 week.

22. The system according to claim 3, wherein the system can be executed systematically.

23. The system according to claim 3, wherein the system can be executed one full time in less than 1 week.

24. The system according to claim 3, wherein the identification means step is preceded by the communication of a series of inputs about the intellectual property asset by a user.

25. The system according to claim 24, wherein the input that precedes the identification means step is communicated via a point and click computer-user interface presented to the user via a mobile phone app.

26. The system according to claim 25, wherein the system can be operated one full time in less than 1 week.

27. The system according to claim 24, wherein the input that precedes the identification means step is communicated via a point and click computer-user interface presented to the user via the internet.

28. The system according to claim 27, wherein the system can be operated one full time in less than 1 week.

29. The system according to claim 24, wherein the input that precedes the identification means step is communicated via a point and click computer-user interface presented to the user via a tablet computer device.

30. The system according to claim 29, wherein the system can be operated one full time in less than 1 week.

31. The product according to claim 4, wherein the product is sold via e-commerce, over the phone, via mobile phone applications, or other similar means, wherein the intellectual property asset can be identified, and the risks associated therewith are minimized, reduced or spread.

32. The product according to claim 4, wherein the intellectual property asset can be identified, and the risks associated therewith are minimized, reduced or spread in 1 week or less.

33. The product according to claim 4, wherein the risk in the title and other defects for said intellectual property asset are minimized, reduced or spread via an agreement between the user and a third party wherein the third party agrees to insure the risk up to a certain limit.

34. The product according to claim 33, wherein the agreement is reached based on a price that is less than five percent of the value of the limit.

35. The product according to claim 34, wherein the agreement is reached in less than 1 week.

36. The product according to claim 33, wherein the agreement is reached in less than 1 week.

37. The product according to claim 33, wherein the user's request that an agreement be reached is initiated via a point and click computer-user interface presented to the purchaser via the interne.

38. The product according to claim 37, wherein the agreement is reached in less than 1 week.

39. The product according to claim 37, wherein the agreement is reached based on a price that is less than five percent of the value of the limit.

40. The product according to claim 33, wherein the user's request that an agreement be reached is initiated via a point and click computer-user interface presented to the purchaser via a mobile phone app.

41. The product according to claim 40, wherein the agreement is reached in less than 1 week.

42. The product according to claim 40, wherein the agreement is reached based on a price that is less than five percent of the value of the limit.

43. The product according to claim 42, wherein the agreement is reached in less than 1 week.

44. The product according to claim 33, wherein the user's request that an agreement be reached is initiated via a point and click computer-user interface presented to the purchaser via a tablet computer device.

45. The product according to claim 44, wherein the agreement is reached in less than 1 week.

46. The product according to claim 44, wherein the agreement is reached based on a price that is less than five percent of the value of the limit.

47. The product according to claim 46, wherein the agreement is reached in less than 1 week.
